(19) United States
(12) Patent Application Publication
(10) Pub. No.: US 2024/0043688 A1
(43) Pub. Date: Feb. 8, 2024

(54) STABILIZED SILOXANE PARTICLES AND METHODS FOR MAKING AND USING THE SAME

(71) Applicant: Florida State University Research Foundation, Inc., Tallahassee, FL (US)

(72) Inventors: Joseph SCHLENOFF, Tallahassee, FL (US); Sandrine LTEIF, Tallahassee, FL (US)

(21) Appl. No.: 18/356,657

(22) Filed: Jul. 21, 2023

Related U.S. Application Data
(60) Provisional application No. 63/369,120, filed on Jul. 22, 2022.

(51) Int. Cl. C08L 83/04; C09D 183/04

(52) U.S. Cl. CPC C08L 83/04; C09D 183/04; C08L 2203/02

(57) ABSTRACT

Described herein stabilized polysiloxane particles and methods for making and using the same. In one aspect, the composite includes (a) a polysiloxane comprising one or more positively charged groups and a negatively charged polyelectrolyte polymer or (b) a polysiloxane comprising one or more negatively charged groups and a positively charged polyelectrolyte polymer. Additionally, components such as, for example, inorganic drying agent, a filler, a reinforcing agent, magnetic particles, a wet/dry indicator, a pharmaceutical agent, a catalyst, or any combination thereof. The composites are effective in encapsulating hydrophobic materials that can subsequently be dispersed in aqueous medium.

### CROSS-REFERENCE TO RELATED APPLICATIONS

This application claims the benefit of and priority to co-pending U.S. Provisional Patent Application No. 63/369,120, filed on Jul. 22, 2022, the contents of which are incorporated by reference herein in its entirety.

### STATEMENT REGARDING FEDERALLY SPONSORED RESEARCH OR DEVELOPMENT

This invention was made with government support under DMR 1809304 awarded by the National Science Foundation. The government has certain rights in the invention.

### BACKGROUND

Oligomeric or polymeric forms of polydimethyl siloxane (PDMS) are used widely in the personal care and coatings industries. PDMS itself is hydrophobic and deposits as a slick, hydrophobic layer on surfaces. Low molecular weight or oligomeric PDMS is a viscous liquid, often termed “silicone oil,” which is used extensively for lubrication and water repellency.

PDMS is flexible molecule having a low glass transition temperature (about −123° C.), which means it is rubbery or fluid-like at temperatures above. In order to decrease fluidity, chemical crosslinking may be introduced, which provides a rubbery material known as silicone rubber. Because silicone rubber maintains flexibility over a wide range of temperatures, it has many industrial uses such as for o-rings and vibration isolation. In the absence of chemical crosslinking, PDMS remains a fluid with a viscosity that increases with increasing molecular weight.

Dispersions of PDMS in water are often used as waterproof coatings and treatments. Unfortunately, because PDMS is hydrophobic, the dispersions are inherently unstable and PDMS tends to aggregate. PDMS emulsions must be stabilized by adding surface active agents (surfactants) to produce emulsions of PDMS droplets. Within these emulsions, the PDMS droplet size may range from about 10 to about 1000 nanometers. With sufficient size, the emulsion droplets do not remain suspended, and the mixture must be shaken to resuspend the PDMS. Therefore, there is a need for stable PDMS emulsions or dispersions with particle sizes of less than 1000 nm in diameter, preferably less than 200 nm in diameter.

In certain aspects, surfactants are not desired in the end-use of PDMS emulsions. Therefore, there is a need to produce stable siloxane emulsions that do not require the use of surfactants.

An alternative method of producing PDMS emulsions is to induce chemical crosslinking within the PDMS, similar in strategy to producing silicone rubber. Though stable, the liquid-like properties of PDMS are reduced with crosslinking so the PDMS does not coat surfaces as efficiently. There is also a need to produce stable aqueous emulsions or suspensions comprising PDMS particles that are not crosslinked.

### SUMMARY

Described herein stabilized polysiloxane particles and methods for making and using the same. In one aspect, the composite includes (a) a polysiloxane comprising one or more positively charged groups and a negatively charged polyelectrolyte polymer or (b) a polysiloxane comprising one or more negatively charged groups and a positively charged polyelectrolyte polymer. Additionally, components such as, for example, inorganic drying agent, a filler, a reinforcing agent, magnetic particles, a wet/dry indicator, a pharmaceutical agent, a catalyst, or any combination thereof. The composites are effective in encapsulating hydrophobic materials that can subsequently be dispersed in aqueous medium.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows autocorrelation function and hydrodynamic radius, Rₕ, distribution of 1 mg ml⁻¹ nanoparticle at an angle of 90° at 296.8K of PDMS-NH₃⁺ (—) and PSS-PDMS-NH₃⁺ (—).

FIGS. 2A-2B show (A) hydrodynamic radius, Rₕ, distribution of 1 mg ml⁻¹ PDMS-NH₃⁺ nanoparticle in 0.15 M NaCl and (B) Rₕ 1 mg·ml⁻¹ PDMS-NH₃⁺ nanoparticle (♦) and PSS-PDMS-NH₃⁺ nanoparticle (●) in 0.15M NaCl vs. time.

FIG. 3 shows PDMS-NH₃⁺ nanoparticles on a silicon wafer. X-Y images are 1×1 μm.

FIGS. 4A-4B show (A) linear viscoelastic response (G′ filled, G″ empty symbols) of PSS-PDMS-NH₃⁺ film (squares) PDMS-NH₃⁺ (triangles) and PDMS-NH₂ (circles) and (B) viscoelastic measurements at 0.1% strain while ramping temperature at 1° C. min⁻¹ for the PSS-PDMS-NH₃⁺ film. Storage modulus (G′, heating ▪, cooling □), loss modulus (G″, ▪, cooling □) and tan δ (heating ●, cooling ∘).

FIG. 5 shows small, mid and wide-angle x-ray scattering profiles of PSS-PDMS-NH₃⁺ 1 wt % NP solution (blue), PDMS-NH₂ (purple), PDMS-NH₃⁺ (green) and PSS-PDMS-NH₃⁺ NC-film (red).

FIG. 6 shows a schematic representation of nanoparticles of PDMS. Representing positively charged PDMS micelles with charges decorating the surface and PSS forming a glassy shell. PSS also connects some of the PDMS micelles by PSS bridges. The cluster of micelles shown is suspended as particles in solution with diameters of about 120 nm.

FIGS. 7A-7B show (A) autocorrelation function and hydrodynamic radius, Rₕ, distribution of 0.1 mg ml⁻¹ composite of Au-PDMS-NH₃⁺ (0.016 mg ml⁻¹ AuNP) ( [symbol] ) and Au— PDMS-NH₃⁺ PSS (0.016 mg ml⁻¹ AuNP and 0.06 mg ml⁻¹ PSS) ( [symbol] ) 95:5 water: TH at 296.8 K and (B) UV-Vis absorbance vs. wavelength of 0.1 mg mL⁻¹ Au-PDMS-NH₃⁺ ( [symbol] ) (SPR peak at 522 nm), Au— PDMS-NH₃⁺ PSS ( [symbol] ) (SPR peak at 523 nm) and PDMS-NH₃⁺ (−) with no absorbance peak. Room temperature.

FIGS. 8A-8C show TEM images of a 0.1 mg mL⁻¹ Au-PDMS-NH₃⁺ nanodroplets at different magnifications from (A) to (C). STEM image B shows 146 gold nanoparticles (in white) clustered in a ring. AuNP radius 4.7±1.5 nm.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a solvent” include, but are not limited to, mixtures or combinations of two or more such solvents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. It is also contemplated that, in certain aspects, unless expressly indicated to the contrary, individual substituents can be further optionally substituted (i.e., further substituted or unsubstituted).

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C1 alkyl, C1-C2 alkyl, C1-C3 alkyl, C1-C4 alkyl, C1-C5 alkyl, C1-C6 alkyl, C1-C7 alkyl, C1-C8 alkyl, C1-C9 alkyl, C1-C10 alkyl, and the like up to and including a C1-C24 alkyl.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. Alternatively, the term “monohaloalkyl” specifically refers to an alkyl group that is substituted with a single halide, e.g. fluorine, chlorine, bromine, or iodine. The term “polyhaloalkyl” specifically refers to an alkyl group that is independently substituted with two or more halides, i.e. each halide substituent need not be the same halide as another halide substituent, nor do the multiple instances of a halide substituent need to be on the same carbon. The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The term “heterocycloalkyl” is a type of cycloalkyl group as defined above and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, cycloalkyl, alkoxy, amino, ether, halide, hydroxy, nitro, silyl, sulfo-oxo, or thiol as described herein. In one aspect, the heterocycloalkyl group can be a lactam, including but not limited to an N-substituted lactam.

The term “aryl” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl to two aryl groups that are bound together via a fused ring structure, as in naphthalene, or are attached via one or more carbon-carbon bonds, as in biphenyl. Fused aryl groups including, but not limited to, indene and naphthalene groups are also contemplated.

The term “heteroaryl” as used herein refers to an aromatic group that has at least one heteroatom incorporated within the ring of the aromatic group. Examples of heteroatoms include, but are not limited to, nitrogen, oxygen, sulfur, and phosphorus, where N-oxides, sulfur oxides, and dioxides are permissible heteroatom substitutions. The heteroaryl group can be substituted or unsubstituted. The heteroaryl group can be substituted with one or more groups including, but not limited to, alkyl, cycloalkyl, alkoxy, amino, ether, halide, hydroxy, nitro, silyl, sulfo-oxo, or thiol as described herein. Heteroaryl groups can be monocyclic, or alternatively fused ring systems. Heteroaryl groups include, but are not limited to, furyl, imidazolyl, pyrimidinyl, tetrazolyl, thienyl, pyridinyl, pyrrolyl, N-methylpyrrolyl, quinolinyl, isoquinolinyl, pyrazolyl, triazolyl, thiazolyl, oxazolyl, isoxazolyl, oxadiazolyl, thiadiazolyl, isothiazolyl, pyridazinyl, pyrazinyl, benzofuranyl, benzodioxolyl, benzothiophenyl, indolyl, indazolyl, benzimidazolyl, imidazopyridinyl, pyrazolopyridinyl, and pyrazolopyrimidinyl. Further not limiting examples of heteroaryl groups include, but are not limited to, pyridinyl, pyridazinyl, pyrimidinyl, pyrazinyl, thiophenyl, pyrazolyl, imidazolyl, benzo[d]oxazolyl, benzo[d]thiazolyl, quinolinyl, quinazolinyl, indazolyl, imidazo[1,2-b]pyridazinyl, imidazo[1,2-a]pyrazinyl, benzo[c][1,2,5]thiadiazolyl, benzo[c][1,2,5]oxadiazolyl, and pyrido[2,3-b]pyrazinyl.

The term “aralkyl” as used herein is an aryl group as defined herein where one or more atoms of the aryl group is substituted with an alkylene group as defined herein. An example of an aralkyl group is a benzyl group (C₆H₅—CH₂—).

The term “alkylene” as used herein is a branched or unbranched saturated hydrocarbon group of 1 to 24 carbon atoms represented by the general formula (CH₂)ₙ, such as ethylene, propylene, butylene, and the like. The alkylene group can be unsubstituted or substituted as described herein.

The term “halide,” as used herein can be used interchangeably and refer to F⁻, Cl⁻, Br⁻, or I⁻.

The term “carboxylate” as used herein is represented by the formula RC(O)O⁻, where R is an alkyl group, cycloalkyl group, or aryl group as defined above.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to conduct the methods of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

### Stabilized Polysiloxanes

Described herein stabilized polysiloxane particles and methods for making and using the same. Polysiloxanes have numerous applications. However, due to their hydrophobic properties, they have limited applications in aqueous medium. The composites described herein address this problem, where the polysiloxane functionalized with chargeable groups is complexed with oppositely charged polyelectrolytes.

Not wishing to be bound by theory, the polysiloxane includes charged groups that interact electrostatically with functional groups on oppositely charged polyelectrolytes to form droplets in aqueous media. The polyelectrolyte coats the polysiloxane, providing a shell, which stabilizes the polysiloxane droplet against coalescing or aggregating with other droplets. The result is a stable suspension of polysiloxane in aqueous media, where the polysiloxane is encapsulated by the polyelectrolyte to produce a core composed of polysiloxane with a polyelectrolyte shell.

In one aspect, the composite includes (a) a polysiloxane comprising one or more positively charged groups and a negatively charged polyelectrolyte polymer or (b) a polysiloxane comprising one or more negatively charged groups and a positively charged polyelectrolyte polymer. The components and methods for making the composites are described below.

Polysiloxanes

Polysiloxanes are materials composed of a plurality of —Si—O—Si— linkages. In one aspect, the hydrophobic material is a dialkylpolysiloxane having the repeat units in structure I

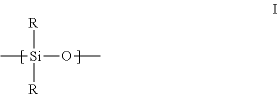

where each R is an alkyl group. In one aspect, each alkyl group is the same alkyl group. In another each alkyl group is a C1 to C10 branched alkyl group such as, for example, methyl, ethyl, butyl, and the like. In another aspect, the hydrophobic material is polydimethylsiloxane (PDMS).

The negatively charged group on the polysiloxane can be any group that possesses a negative charge or, in the alternative, is a group that can be converted to a negatively charged group (e.g., a group that is reacted with a base to produce a negatively charged group). In one aspect, the negatively charged group on the polysiloxane includes a sulfonate group, a carboxylate group, a phosphate group, or a phosphonate group.

The positively charged group on the polysiloxane can be any group that possesses a positive charge or, in the alternative, is a group that can be converted to a positively charged group (e.g., a group that is reacted with an acid to produce a positively charged group).

In one aspect, the positively charged polysiloxane includes one or more quaternary ammonium groups covalently bonded to the polysiloxane. The term “quaternary ammonium group” is a group bearing a permanently positively charged nitrogen atom, as opposed to an amine, which may be protonated.

In one aspect, the quaternary ammonium group has the structure II

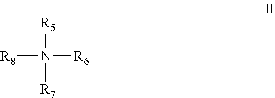

wherein R₅ is an aryl group or an alkylene group and is covalently bonded to the polymer backbone, and R₆, R₇ and R₈ are independently an alkyl group or an aryl group. In one aspect, R₆, R₇ and R₈ are each a C₁ to C₅ alkyl group. In another aspect, R₆, R₇ and R₈ are each a methyl group.

In one aspect, the quaternary ammonium group comprises a nitrogen-bearing heteroaryl group, wherein nitrogen is alkylated. For example, the heteroaryl group can be a pyridinium group such as a N-methylvinylpyridinium (MVP). In another aspect, the quaternary ammonium group comprises a nitrogen-bearing cycloalkyl group (e.g., a four- to seven-member ring), wherein nitrogen is alkylated. Non-limiting examples of these groups are provided in Table 1.

TABLE 1
Polyelectrolyte Repeat Units

| Name | Structure |
|---|---|
| diallyldimethylammonium (PDADMA) | 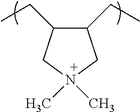 |
| N-methyl-2-vinyl pyridinium (PM2VP) | 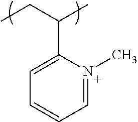 |
| N-methyl-4-vinylpyridinium (PM4VP) | 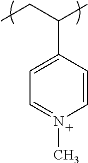 |
| N-octyl-4-vinylpyridinium (PNO4VP) | 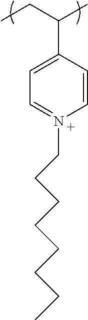 |
| N-methyl-2-vinyl pyridinium-co- ethyleneoxide (PM2VP-co-PEO) | 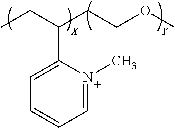 |
| | X and Y denote proportions |
| | of repeat units |
| acrylic acid (PAA) | 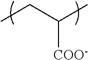 |
| allylamine (PAH) | 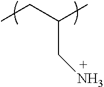 |
| ethyleneimine (PEI) | 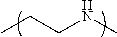 |

The position of the positively charged group or a negatively charged group in the polysiloxane. In one aspect, the polysiloxane includes a positively charged group or a negatively charged group at one or both ends of the polysiloxane. An example of this provided in the examples below, where PDMS is end-capped with one or two amine groups. The amine groups can ultimately be protonated to produce positively charged ammonium groups.

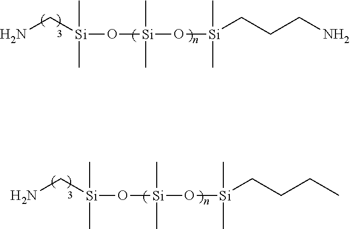

In another aspect, the polysiloxane includes a positively charged group or a negatively charged group that is incorporated in the backbone of the polysiloxane or pendant to the polysiloxane backbone. An example of this is provided below, where the amin group is pendant to the polysiloxane backbone.

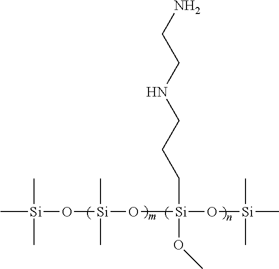

In one aspect, the molecular weight (number average) of the polysiloxane is typically about 1,000 to about 5,000,000 grams/mole, or about 10,000 grams/mole to about 1,000,000 grams/mole, or 10,000 grams/mole, 50,000 grams/mole, 100,000 grams/mole, 150,000 grams/mole, 200,000 grams/mole, 250,000 grams/mole, 300,000 grams/mole, 350,000 grams/mole, 400,000 grams/mole, 450,000 grams/mole, 500,000 grams/mole, 550,000 grams/mole, 600,000 grams/mole, 650,000 grams/mole, 700,000 grams/mole, 750,000 grams/mole, 800,000 grams/mole, 850,000 grams/mole, 900,000 grams/mole, 950,000 grams/mole, or 1,000,000 grams/mole, where any value can be a lower or upper endpoint of a range (e.g., 450,000 grams/mole to 800,000 grams/mole).

In another aspect, a polysiloxane have charged group(s) can be mixed with a polysiloxane having no charge. Not wishing to be bound by theory, the uncharged polysiloxane in aqueous media migrates away from the PDMS/water interface, adding to the core of the polysiloxane droplet. In another aspect, two or more different polysiloxanes each with positively charged groups or negatively charged groups can be used.

Polyelectrolytes

The polyelectrolytes used to form the composites described herein are water and/or organic soluble and comprise one or more monomer repeat units that are positively or negatively charged. The polyelectrolytes may be copolymers that have a combination of charged and/or neutral monomers (e.g., positive and neutral, negative and neutral; positive and negative; or positive, negative, and neutral). Regardless of the exact combination of charged and neutral monomers, the polyelectrolyte is predominantly positively charged or predominantly negatively charged and hereinafter is referred to as a “positively charged polyelectrolyte polymer” or a “negatively charged polyelectrolyte polymer,” respectively.

In one aspect, the polyelectrolytes can be described in terms of the average charge per repeat unit in a polymer chain. For example, a copolymer composed of 100 neutral and 300 positively charged repeat units has an average charge of 0.75 (3 out of 4 units, on average, are positively charged). As another example, a copolymer that has 100 neutral, 100 negatively charged, and 300 positively charged repeat units would have an average charge of 0.4 (100 negatively charged units cancel 100 positively charged units leaving 200 positively charged units out of a total of 500 units). Thus, a positively charged polyelectrolyte has an average charge per repeat unit between 0 and 1 and a negatively charged polyelectrolyte has an average charge per repeat unit between 0 and −1. An example of a positively charged copolymer is PDADMA-co-PAC (i.e., poly(diallyldimethylammonium chloride) and polyacrylamide copolymer) in which the PDADMA units have a charge of 1 and the PAC units are neutral so the average charge per repeat unit is less than 1.

In one aspect, the positively-charged polyelectrolyte has an average charge per repeat unit of about 0.1 to 1, or 0.1, 0.15, 0.2, 0.25, 0.3, 0.35, 0.4, 0.15, 0.45, 0.5, 0.55, 0.6, 0.65, 0.7, 0.75, 0.8, 0.85, 0.9, 0.95, or 1.0, where any value can be a lower and upper endpoint of a range (e.g., 0.2 to 0.55). In another aspect, the negatively-charged polyelectrolyte has an average charge per repeat unit of about −0.1 to −1, or −0.1, −0.15, −0.2, −0.25, −0.3, −0.35, −0.4, −0.15, −0.45, −0.5, −0.55, −0.6, −0.65, −0.7, −0.75, −0.8, −0.85, −0.9, −0.95, or −1.0, where any value can be a lower and upper endpoint of a range (e.g., −0.2 to −0.55).

Some polyelectrolytes include equal numbers of positive repeat units and negative repeat units distributed throughout the polymer in a random, alternating, or block sequence. For examples, a polyelectrolyte may include 100 randomly distributed styrene sulfonate repeat units (negative) and 100 diallyldimethylammonium chloride repeat units (positive), said molecule having a net charge of zero. These amphiphilic polyelectrolytes also mix on the molecular level and are suitable for this invention. In one aspect, amphiphilic polyelectrolytes used herein include equal numbers of positive and negative repeat units.

In another aspect, the polyelectrolytes include a repeat unit that has both a negative and positive charge. Such repeat units are termed “zwitterionic” and the polyelectrolyte is termed a “zwitterionic polyelectrolyte.” Though zwitterionic repeat units contribute equal number of positive and negative repeat units, the zwitterionic group is still solvated and relatively hydrophilic. An example of a zwitterionic repeat unit is 3-[2-(acrylamido)-ethyldimethyl ammonio] propane sulfonate, AEDAPS. Zwitterionic groups are present on polyelectrolytes as blocks or randomly dispersed throughout the polymer chain. In one aspect, the polyelectrolytes include between about 1% and about 90% zwitterion units, and more preferably said polyelectrolyte comprises between about 10% and about 70% zwitterionic units. In other aspects, the polyelectrolytes having zwitterionic repeat units also include between about 10% and about 90% non-zwitterionic charged repeat units.

The charges on a polyelectrolyte may be derived directly from the monomer units used to make the polyelectrolyte, or they may be introduced by chemical reactions on a precursor polymer. For example, PDADMA is made by polymerizing diallyldimethylammonium chloride, a positively charged water soluble vinyl monomer. PDADMA-co-PAC is made by the polymerization of a mixture of diallyldimethylammonium chloride and acrylamide (a neutral monomer which remains neutral in the polymer). Poly(styrenesulfonic acid) is often made by the sulfonation of neutral polystyrene. Poly(styrenesulfonic acid) can also be made by polymerizing the negatively charged styrene sulfonate monomer. The chemical modification of precursor polymers to produce charged polymers may be incomplete and typically result in an average charge per repeat unit that is less than 1. For example, if only about 80% of the styrene repeat units of polystyrene are sulfonated, the resulting poly(styrenesulfonic acid) has an average charge per repeat unit of about −0.8.

In one aspect, the positively charged polyelectrolyte polymer comprises a plurality of quaternary ammonium groups as defined above covalently bonded to the positively charged polyelectrolyte polymer.

In one aspect, the quaternary ammonium group has the structure I

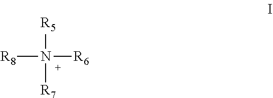

wherein R₅ is an aryl group or an alkylene group and is covalently bonded to the polymer backbone, and R₆, R₇ and R₈ are independently an alkyl group or an aryl group. In one aspect, R₆, R₇ and R₈ are each a C₁ to C₅ alkyl group. In another aspect, R₆, R₇ and R₈ are each a methyl group.

In one aspect, the quaternary ammonium group comprises a nitrogen-bearing heteroaryl group, wherein nitrogen is alkylated. For example, the heteroaryl group can be a pyridinium group such as a N-methylvinylpyridinium (MVP). In another aspect, the quaternary ammonium group comprises a nitrogen-bearing cycloalkyl group (e.g., a four- to seven-member ring), wherein nitrogen is alkylated. Non-limiting examples of these groups are provided in Table 1 above.

Examples of a positively-charged synthetic polyelectrolyte include polyelectrolytes having a quaternary ammonium group, such as poly(diallyldimethylammonium chloride) (PDADMA), poly(vinylbenzyltrimethylammonium) (PVBTA), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), including poly(N-methyl-2-vinylpyridinium) (PM2VP), other poly(N-alkylvinylpyridines), and copolymers thereof; protonated polyamines such as poly(allylaminehydrochloride) (PAH), polyvinylamine, polyethyleneimine (PEI); polysulfoniums, and polyphosphoniums.

In one aspect, the negatively charged polyelectrolyte polymer comprises a plurality of sulfonate groups, carboxylate groups, phosphate groups, phosphonate groups, or any combination thereof covalently bonded to the negatively charged polyelectrolyte polymer.

Examples of a negatively-charged synthetic polyelectrolyte include polyelectrolytes having a sulfonate group (—SO₃⁻), such as, for example, poly(styrenesulfonic acid) (PSS), poly(2-acrylamido-2-methyl-1-propane sulfonic acid) (PAMPS), sulfonated poly (ether ether ketone) (SPEEK), poly(ethylenesulfonic acid), poly(methacryloxyethylsulfonic acid), their salts, and copolymers thereof; polycarboxylates such as poly(acrylic acid) (PAA) and poly(methacrylic acid), polyphosphates, and polyphosphonates.

Further examples of polyelectrolytes include charged biomacromolecules, which are naturally occurring polyelectrolytes, or synthetically modified charged derivatives of naturally occurring biomacromolecules, such as modified celluloses, chitosan, or guar gum. A positively charged biomacromolecule usually comprises a protonated sub-unit (e.g., protonated amines). Some negatively charged biomacromolecules comprise a deprotonated sub-unit (e.g., deprotonated carboxylates or phosphates). Examples of biomacromolecules which may be charged for use in accordance with the present invention include proteins, polypeptides, enzymes, DNA, RNA, glycosaminoglycans, alginic acid, chitosan, chitosan sulfate, cellulose sulfate, polysaccharides, dextran sulfate, carrageenin, glycosaminoglycans, sulfonated lignin, and carboxymethylcellulose.

In one aspect, the molecular weight (number average) of synthetic polyelectrolyte molecules is typically about 1,000 to about 5,000,000 grams/mole, or about 10,000 grams/mole to about 1,000,000 grams/mole, or 10,000 grams/mole, 50,000 grams/mole, 100,000 grams/mole, 150,000 grams/mole, 200,000 grams/mole, 250,000 grams/mole, 300,000 grams/mole, 350,000 grams/mole, 400,000 grams/mole, 450,000 grams/mole, 500,000 grams/mole, 550,000 grams/mole, 600,000 grams/mole, 650,000 grams/mole, 700,000 grams/mole, 750,000 grams/mole, 800,000 grams/mole, 850,000 grams/mole, 900,000 grams/mole, 950,000 grams/mole, or 1,000,000 grams/mole, where any value can be a lower or upper endpoint of a range (e.g., 450,000 grams/mole to 800,000 grams/mole). The molecular weight of naturally occurring polyelectrolyte molecules (i.e., biomacromolecules), however, can reach as high as 10,000,000 grams/mole.

Many of the polyelectrolytes useful herein, such as PDADMA and PEI, exhibit some degree of branching. Branching may occur at random or at regular locations along the backbone of the polymer. Branching may also occur from a central point and in such a case the polymer is referred to as a “star” polymer, if generally linear strands of polymer emanate from the central point. If, however, branching continues to propagate away from the central point, the polymer is referred to as a “dendritic” polymer. Branched polyelectrolytes, including star polymers, comb polymers, graft polymers, and dendritic polymers, are also suitable for purposes of this invention. Block polyelectrolytes, wherein a macromolecule comprises at least one block of charged repeat units, are also suitable. In one aspect, the number of blocks may be 2 to 5, preferably 2 or 3. In one aspect, if the number of blocks is 3 the block arrangement is ABA.

Many of the foregoing polyelectrolytes have very low toxicity. For example, poly(diallyldimethylammonium chloride), poly(2-acrylamido-2-methyl-1-propane sulfonic acid) and their copolymers are used in the personal care industry, e.g., in shampoos. Also, because some of the polyelectrolytes used in the method of the present invention are synthetic or synthetically modified natural polymers, their properties (e.g., charge density, viscosity, water solubility, and response to pH) may be tailored by adjusting their composition.

Polyelectrolyte solutions used to produce the polyelectrolyte complexes include a solvent. An appropriate solvent is one in which the selected polyelectrolyte is soluble. Thus, the appropriate solvent is dependent upon whether the polyelectrolyte is considered to be hydrophobic or hydrophilic. A hydrophobic polymer displays less favorable interaction energy with water than a hydrophilic polymer. While a hydrophilic polymer is water soluble, a hydrophobic polymer may only be sparingly soluble in water, or, more likely, insoluble in water. Likewise, a hydrophobic polymer is more likely to be soluble in organic solvents than a hydrophilic polymer.

In general, the higher the carbon to charge ratio of the polymer, the more hydrophobic it tends to be. For example, polyvinyl pyridine alkylated with a methyl group (PNMVP) is considered to be hydrophilic, whereas polyvinyl pyridine alkylated with an octyl group (PNOVP) is considered to be hydrophobic. Thus, water is preferably used as the solvent for hydrophilic polyelectrolytes and organic solvents such as ethanol, methanol, dimethylformamide, acetonitrile, carbon tetrachloride, and methylene chloride are preferably used for hydrophobic polyelectrolytes. Even if polyelectrolyte complexes are prepared by mixing organic-soluble and water-soluble polymers, the complex is preferably rinsed to remove organic solvents before it is dried according to the method described herein. Some organic solvents are hard to remove even with extensive rinsing. Therefore, the preferred solvent for polyelectrolyte complexation is water.

Because the target material for sorption is water, in one aspect, the polyelectrolyte complexes described herein are made from hydrophilic repeat units. In another aspect, if any hydrophobic components of the polyelectrolyte complex are included, the finished polyelectrolyte complex does not include more than 10 weight % of non-water-soluble components.

Examples of polyelectrolytes that are soluble in water include, but are not limited to, poly(styrenesulfonic acid), poly(2-acrylamido-2-methyl-1-propane sulfonic acid), sulfonated lignin, poly(ethylenesulfonic acid), poly(methacryloxyethylsulfonic acid), poly(acrylic acids), poly(methacrylic acids), their salts, and copolymers thereof; as well as poly(diallyldimethylammonium chloride), poly(vinylbenzyltrimethylammonium), ionenes, poly(acryloxyethyltrimethyl ammonium chloride), poly(methacryloxy(2-hydroxy)propyltrimethyl ammonium chloride), and copolymers thereof; and polyelectrolytes comprising a pyridinium group, such as, poly(N-methylvinylpyridium), and protonated polyamines, such as, poly(allylamine hydrochloride), polyvinylamine and poly(ethyleneimine).

Some polyelectrolytes include rigid rod backbones, such as aromatic backbones, or partially aromatic backbones, including sulfonated polyparaphenylene, sulfonated polyetherether ketones (SPEEK), sulfonated polysulfones, sulfonated polyarylenes, sulfonated polyarylene sulfones, and polyarylenes comprising alkylammonium groups.

In certain aspects, the charged polyelectrolyte may be a synthetic copolymer comprising pH sensitive repeat units, pH insensitive repeat units, or a combination of pH sensitive repeat units and pH insensitive repeat units. pH insensitive repeat units maintain the same charge over the working pH range of use. The rationale behind such a mixture of pH sensitive groups and pH insensitive groups on the same molecule is that the pH insensitive groups interact with other, oppositely charged pH insensitive groups on other polymers, holding the polyelectrolyte complex together despite the state of ionization of the pH sensitive groups.

For example, poly(acrylic acids) and derivatives begin to take on a negative charge within the range of about pH 4 to about 6 and are negatively charged at higher pH levels. Below this transition pH range, however, poly(acrylic acids) are protonated (i.e., uncharged). Similarly, polyamines and derivative thereof take on a positive charge if the pH of the solution is below their pKₐ. As such, and in accordance with the present invention, the pH of a polyelectrolyte solution may be adjusted by the addition of an acid and/or base in order to attain, maintain, and/or adjust the electrical charge of a polyelectrolyte at the surface of, or within, a polyelectrolyte complex.

The state of ionization, or average charge per repeat unit, for polyelectrolytes bearing pH sensitive groups depends on the pH of the solution. For example, a polyelectrolyte comprising 100 pH insensitive positively charged units, such as DADMA, and 30 pH sensitive negatively charged units, such as acrylic acid (AA), will have a net charge of +100 at low pH (where the AA units are neutral) and an average of +100/130 charge per repeat unit, and a net charge of +70 at high pH (where 30 ionized AA units cancel out 30 of the positive charges) and an average of +70/130 charge per repeat unit. The different monomer units may be arranged randomly along the polymer chain (“random” copolymer) or they may exist as blocks (“block” copolymer). The average charge per repeat unit is also known as the “charge density.”

pH sensitive polyelectrolyte complexes include pH sensitive polymeric repeat units including moieties such as, for example, carboxylates, pyridines, imidazoles, piperidines, phosphonates, primary, secondary and tertiary amines, and combinations thereof. In one aspect, the polyelectrolytes include copolymers comprising carboxylic acids, such as poly(acrylic acids), poly(methacrylic acids), poly(carboxylic acids), and copolymers thereof. Additional preferred polyelectrolytes comprise protonatable nitrogen atoms, such as poly(pyridines), poly(imidazoles), poly(piperidines), and poly(amines) bearing primary, secondary or tertiary amine groups, such as poly(vinylamines) and poly(allylamine).

To avoid disruption and possible decomposition of the polyelectrolyte complex, polyelectrolytes having pH sensitive repeat units additionally can include pH insensitive charged functionality on the same molecule. In one aspect, the pH insensitive repeat unit is a positively charged repeat unit selected from the group consisting of repeat units containing a quaternary nitrogen atom, a sulfonium (S⁺) atom, or a phosphonium atom. Thus, for example, the quaternary nitrogen may be part of a quaternary ammonium moiety (—N⁺RₐR_{b}R_{c} wherein Rₐ, R_{b}, and R_{c} are independently alkyl, aryl, or mixed alkyl and aryl), a pyridinium moiety, a bipyridinium moiety or an imidazolium moiety, the sulfonium atom may be part of a sulfonium moiety (−S+R_{d}Rₑ wherein R_{d} and Rₑ are independently alkyl, aryl, or mixed alkyl and aryl) and the phosphonium atom may be part of a phosphonium moiety (—P⁺R_{f}R_{g}Rₕ wherein R_{f}, R_{g}, and Rₕ are independently alkyl, aryl, or mixed alkyl and aryl). In another embodiment, the pH insensitive repeat unit is a negatively charged repeat unit selected from the group consisting of repeat units containing a sulfonate (—SO₃⁻), a phosphate (—OPO₃⁻), or a sulfate (—SO₄⁻).

Exemplary negatively charged pH insensitive charged repeat units include styrenesulfonic acid, 2-acrylamido-2-methyl-1-propane sulfonic acid, sulfonated lignin, ethylenesulfonic acid, methacryloxyethylsulfonic acid, sulfonated ether ether ketone, phosphate. In one aspect, the pH insensitive negatively charged polyelectrolytes include polyelectrolytes having a sulfonate group (—SO₃—), such as poly(styrenesulfonic acid) (PSS), poly(2-acrylamido-2-methyl-1-propane sulfonic acid) (PAMPS), sulfonated poly (ether ether ketone) (SPEEK), sulfonated lignin, poly(ethylenesulfonic acid), poly(methacryloxyethylsulfonic acid), their salts, and copolymers thereof.

Exemplary positively charged pH insensitive repeat units include diallyldimethylammonium, vinylbenzyltrimethylammonium, vinylalkylammoniums, ionenes, acryloxyethyltrimethyl ammonium chloride, methacryloxy(2-hydroxy)propyltrimethyl ammonium, N-methylvinylpyridinium, other N-alkylvinyl pyridiniums, a N-aryl vinyl pyridinium, alkyl- or aryl imidazolium, sulfonium, or phosphonium. Preferred pH insensitive positively-charged polyelectrolytes comprising a quaternary ammonium group, such as poly(diallyldimethylammonium chloride) (PDADMA), poly(vinylbenzyltrimethylammonium) (PVBTA), poly(alkyammoniums), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), other poly(N-alkylvinylpyridines), and copolymers thereof.

The pH insensitive polyelectrolyte may include a repeat unit that contains protonatable functionality, wherein the functionality has a pKa outside the range of experimental use. For example, poly(allylamine) has protonatable amine functionality with pKa in the range 8-10 and is fully charged (protonated) if the experimental conditions do not surpass a pH of about 7.

In one aspect, the pH insensitive groups constitute about 10 mol % to about 100 mol % of the repeat units of the polyelectrolyte, or about 10 mol %, 15 mol %, 20 mol %, 25 mol %, 30 mol %, 35 mol %, 40 mol %, 45 mol %, 50 mol %, 55 mol %, 60 mol %, 65 mol %, 70 mol %, 75 mol %, 80 mol %, 90 mol %, 95 mol %, or 100 mol %, where any value can be a lower or upper endpoint of a range (e.g., 20 mol % to 80 mol %). In one aspect, the pH sensitive groups constitute about 30 mol % to about 70 mol % of the repeat units of the polyelectrolyte.

Optionally, the polyelectrolytes can include an uncharged repeat unit that is not pH sensitive in the operating pH range, for example, about pH 3 to about pH 9. Said uncharged repeat unit is preferably hydrophilic. Examples of uncharged hydrophilic repeat units include, but are not limited to, acrylamide, vinyl pyrrolidone, ethylene oxide, and vinyl caprolactam. The structures of these uncharged repeat units are shown in Table 2. In one aspect, uncharged repeat units also include N-isopropylacrylamide and propylene oxide.

TABLE 2
Neutral Repeat Units

| Name | Structure |
|---|---|
| Acrylamide | 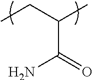 |
| Vinylpyrrolidone | 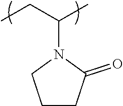 |
| Ethylene oxide | 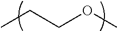 |
| Vinylcaprolactam | 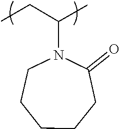 |

In one aspect, the polyelectrolytes include zwitterionic repeat units in the amount of about 10% and about 90% non-zwitterionic charged repeat units. Preferred zwitterionic repeat units are poly(3-[2-(acrylamido)-ethyldimethyl ammonio] propane sulfonate) (PAEDAPS) and poly(N-propane sulfonate-2-vinyl pyridine) (P2PSVP). Examples of other suitable zwitterionic groups are described in U.S. Pat. Pub. No. 20050287111, which is hereby incorporated by reference.

In one aspect, a chemical crosslinking is introduced into the polyelectrolyte for additional stability after deformation. After deformation, for example by extrusion, an article may be treated with a difunctional crosslinking agent, such as XCH₂-φ-CH₂X, where X is a halogen (Cl, Br, or I) and p is a phenyl group. The phenyl group may be replaced by another aromatic or aliphatic moiety, and easily-displaceable groups, such as toluene sulfonate, may replace the halogen. In one aspect, the crosslinking agent is a dihalogenated compound, such as an aromatic or aliphatic dibromide, which is able to alkylate residual unalkylated units on two adjoining polyelectrolyte chains.

In another aspect, the method of chemical crosslinking the polyelectrolyte is heat treatment. For example, amide crosslinks can be formed by heating polyelectrolytes having amine and carboxylic acid groups. In another aspect, a carbodiimide can be added to the polyelectrolytes to activate chemical crosslinking. The level of chemical crosslinking is between about 0.01% and about 50% as measured as a percentage of total ion pairs within the polyelectrolyte complex, or about 0.01%, 0.05%, 0.1%, 0.5%, 1%, 2%, 4%, 6%, 8%, 10%, 15%, 20%, 25%, 30%, 35%, 40%, 45%, or 50%, 8%, where any value can be a lower or upper endpoint of a range (e.g., 0.1% to 10%).

In another aspect, chemical crosslinking of the polyelectrolyte can be performed by photocrosslinking. Photocrosslinking may be achieved by the light-induced decomposition or transformation of functional groups, such as diarylbenzophenones, that form part of the polymer molecules. In another aspect, photocrosslinking of a polyelectrolyte may be accomplished by infusing the reformed polyelectrolyte with a small photoactive crosslinker molecule, such as diazidostilbene, then exposing the polyelectrolyte complex to light.

In other aspects, the polyelectrolyte includes further physical crosslinks created by hydrogen bonding. Hydrogen bonding is weaker than chemical bonding and occurs between a hydrogen bond donor and a hydrogen bond acceptor. Hydrogen bonds are minimally impacted by the presence of salt and thus the level of physical crosslinking due to hydrogen bonding remains substantially the same as the salt concentration is varied. Accordingly, the polyelectrolyte further comprises polymer repeat units capable of hydrogen bonding.

Additives

Polysiloxanes in general are hydrophobic materials. Thus, the composites described herein are useful in solubilizing and entrapping a variety of different hydrophobic molecules without the use of volatile organic solvents (VOS), which in general present health risks.

In one aspect, the additive can include fragrant organic molecules and/or molecules with biomedical properties, such as anti-inflammation agents or anti-dandruff agents for use in home or personal care products (e.g., shampoos, soaps, deodorants, etc.) For example, piroctone olamine, also known as octopirox, is an effective anti-dandruff agent that can be incorporated into the composites described herein.

In another aspect, the composites can include hydrophobic pharmaceutical agents. For example, anticancer agents such as paclitaxel or doxorubicin can be incorporated into the composites described herein and administered to a subject as an aqueous dispersion. Many pharmaceutical drugs are hydrophobic; therefore, the composites described herein provide an effective means for delivering these compounds to the subject.

In another aspect, the composites can include catalyst. For example, the catalyst can include a metal, metal salt, or metal oxide of a transition metal (e.g., gold, platinum, palladium, rhodium) that are typically used to conduct organic reactions. Catalytic organic reactions are typically conducted in organic solvents. The composites described herein provide an alternative to the use of organic solvents. The organic reactants can be added to the composites with catalyst in aqueous media to conduct the reaction. The reaction product can subsequently be isolated from the aqueous phase.

In another aspect, the additive is inorganic particles that act as fillers and/or reinforcing agents and/or toughening agents, such as metal or semimetal oxide particles (e.g., silicon dioxide, aluminum oxide, titanium dioxide, iron oxide, zirconium oxide, and vanadium oxide), clay minerals (e.g., hectorite, kaolin, laponite, attapulgite, montmorillonite), hydroxyapatite or calcium carbonate.

In another aspect, the composites can include magnetic particles that can be manipulated with a magnetic field. For example, the composites described herein with the magnetic particles may be retrieved after use with a larger permanent magnet.

In another aspect, the additives can include dyes that can provide color and/or stability against degradation by ultraviolet light.

The weight % of additives in the composite depends on many factors, such as the aspect ratio and the degree of modification of physical properties required. Accordingly, the solid additives may be between about 1 wt % to about 90 wt % of the polyelectrolyte complex article, or about 1 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, or 90 wt %, where any value can be a lower or upper endpoint of a range (e.g., 1 wt % to 10 wt %).

### Preparation of the Composites

The composites described herein can be made by mixing the charged polysiloxane and polyelectrolyte. For example, an organic-soluble polysiloxane comprising charged groups may be dissolved in an organic solvent, said solvent being miscible with water. The resulting solution is then rapidly mixed with an aqueous solution comprising a polyelectrolyte of charge opposite to that on the polysiloxane. In one aspect, the mixing process produces turbulence that helps disperse the polysiloxane particles. The charged groups migrate to the water/polysiloxane droplet interface and the uncharged polysiloxane units, being water insoluble, remain towards the core of the polysiloxane droplet. As the droplet is formed the outer charged surface of the polysiloxane complexes with the polyelectrolyte to form a stabilizing shell of polyelectrolyte around the polysiloxane core.

In one aspect, the polysiloxane is mixed with aqueous solution of polyelectrolyte under conditions of high shear in a device such as a shear mixer. Not wishing to be bound by theory, the high shear breaks up the polysiloxane into droplets that are stabilized by polyelectrolyte. The amount of polyelectrolyte in the aqueous solution is sufficient to form a stable complexing shell around the polysiloxane. In one aspect, the molar ratio of the charged groups of the polyelectrolyte polymer to the charged groups on the polysiloxane is from 10:1 to 1:2, or 10:1, 9:1, 8:1, 7:1, 6:1, 5:1, 4:1, 3:1, 2:1, 1:1, or 1:2, where any value can be a lower or upper endpoint of a range (e.g., 5:1 wt % to 3:1).

The size of the composites can be modified depending upon the end-use of the composites. The composite size can be varied based on the amount and molecular weight of the of polysiloxane and polyelectrolyte as well as the mixing technique and parameters (e.g., mixing speed). In one aspect, the composite comprises nanoparticles having a diameter less than 1,000 nm, less than 500 nm, or less than 200 nm. In another aspect, the composite comprises nanoparticles having a diameter of from 10 nm to about 200 nm, or 10 nm, 20 nm, 40 nm, 60 nm, 80 nm, 100 nm, 120 nm, 140 nm, 160 nm, 180 nm, or 200 nm, where any value can be a lower or upper endpoint of a range (e.g., 40 nm to 160 nm).

When the composites include an additive as described herein, in one aspect, the additive is mixed with the polysiloxane or solution of the polysiloxane in organic solvent before mixing with the polyelectrolyte. The additive and polysiloxane are mixed for a sufficient time to endure the additive is evenly dispersed throughout the polysiloxane. After the additive and polysiloxane have been sufficiently mixed, the mixture is mixed with an aqueous solution of the polyelectrolyte.

In certain aspects, when the additive is hydrophilic, the hydrophilic additive can be mixed with a hydrophobic compound prior to mixing with the polysiloxane. Examples of hydrophobic compounds include long chain saturated or unsaturated hydrocarbons such as, for example, C₁₀-C₂₅ acids or amines. In one aspect, the hydrocarbon is oleic acid. In other aspect, the use of a surfactant is optional (i.e., may or may not be present).

Non-limiting procedures for preparing the composites described herein with and without additives are provided in the Examples.

### Applications of the Composites

The composites as described herein can be used in any application where polysiloxanes are generally used. For example, the composites can be applied to a surface of an article as a film, coating, or membrane where it is desirable to increase the water repellency of the surface. In one aspect, the composites can be applied to a surface of an article as an aqueous dispersion using techniques known in the art such as spraying, rolling, spin coating, doctor blading, bar coating, bushing, or dipping. When the dispersion dries, a solid-like coating comprising the composites described herein remain on the surface. The thickness of the coating can vary depending upon the application to form a membrane or film, which may be removed for later use or left in place for extended periods of time.

In other aspects, the composites can be incorporated into a number of different products for personal and home use where the product is primarily a water-based composition. For example, the composites include additives such as active agents that can be incorporated into products such as shampoos, soaps, shaving cream, and other healthcare products.

In other aspect, when the composites include pharmaceutical agents, the composites can be formulated as a pharmaceutical composition with a pharmaceutically-acceptable carrier. As used herein, “pharmaceutically-acceptable carriers” means one or more of a pharmaceutically acceptable diluents, preservatives, antioxidants, solubilizers, emulsifiers, coloring agents, releasing agents, coating agents, sweetening, flavoring and perfuming agents, and adjuvants. The disclosed pharmaceutical compositions can be conveniently presented in unit dosage form and prepared by any of the methods well known in the art of pharmacy and pharmaceutical sciences.

In one aspect, the pharmaceutical agent is incorporated in or part of the polysiloxane core, where the core is encapsulated by polyelectrolyte. For example, one or more hydrophobic pharmaceutical agents can be mixed with the polysiloxane prior to mixing with the polyelectrolyte.

In one aspect, it is especially advantageous to formulate the aforementioned pharmaceutical compositions in unit dosage form for ease of administration and uniformity of dosage. The term “unit dosage form,” as used herein, refers to physically discrete units suitable as unitary dosages, each unit containing a predetermined quantity of active ingredient calculated to produce the desired therapeutic effect in association with the required pharmaceutical carrier. That is, a “unit dosage form” is taken to mean a single dose wherein all active and inactive ingredients are combined in a suitable system, such that the patient or person administering the drug to the patient can open a single container or package with the entire dose contained therein and does not have to mix any components together from two or more containers or packages. Typical examples of unit dosage forms are tablets (including scored or coated tablets), capsules or pills for oral administration; single dose vials for injectable solutions or suspension; suppositories for rectal administration; powder packets; wafers; and segregated multiples thereof. This list of unit dosage forms is not intended to be limiting in any way, but merely to represent typical examples of unit dosage forms.

In other aspects, the composites described herein when formulated with one or more catalysts can be useful in conducting organic reactions in aqueous media in the absence of VOCs or with minimal use of VOCs. VOCs provide numerous heath and environmental issues; thus, the use of the composites described herein in predominantly aqueous media provides an attractive alternative in organic synthesis.

### Aspects

Aspect 1. A composite comprising (a) a polysiloxane comprising one or more positively charged groups and a negatively charged polyelectrolyte polymer or (b) a polysiloxane comprising one or more negatively charged groups and a positively charged polyelectrolyte polymer.

Aspect 2. The composite of Aspect 1, wherein the polysiloxane comprises a dialkylpolysiloxane.

Aspect 3. The composite of Aspect 1, wherein the polysiloxane comprises polydimethylsiloxane (PDMS).

Aspect 4. The composite of any one of Aspects 1-3, wherein the polysiloxane comprises a positively charged group or a negatively charged group at one or both ends of the polysiloxane.

Aspect 5. The composite of any one of Aspects 1-4, wherein the positively charged group comprises a quaternary ammonium group.

Aspect 6. The composite of Aspect 5, wherein the quaternary ammonium group comprises a nitrogen-bearing heteroaryl group, wherein nitrogen is alkylated.

Aspect 7. The composite of Aspect 5, wherein the quaternary ammonium group comprises a nitrogen-bearing cycloalkyl group, wherein nitrogen is alkylated.

Aspect 8. The composite of Aspect 7, wherein the nitrogen-bearing cycloalkyl group, is a four- to seven-member ring.

Aspect 9. The composite of Aspect 5, wherein the quaternary ammonium group has the structure

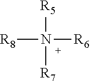

wherein R₅ is an aryl group or an alkylene group and is covalently bonded to the polysiloxane or the positively charged polyelectrolyte polymer, and R₆, R₇ and R₈ are independently an alkyl group or an aryl group.

Aspect 10. The composite of any one of Aspects 1-4, wherein the positively charged group is NH₃⁺.

Aspect 11. The composite of any one of Aspects 1-4, wherein the positively charged polyelectrolyte polymer comprises a protonated or alkylated poly(pyridine), a protonated or alkylated poly(imidazole), a protonated or alkylated a poly(piperidine), or a protonated or alkylated poly(amine).

Aspect 12. The composite of any one of Aspects 1-4, wherein the positively charged polyelectrolyte polymer comprises poly(diallyldimethylammonium chloride) (PDADMA), poly(vinylbenzyltrimethylammonium) (PVBTA), ionenes, poly(acryloxyethyltrimethyl ammonium chloride), poly(methacryloxy(2-hydroxy)propyltrimethyl ammonium chloride), and copolymers thereof, polyelectrolytes comprising a pyridinium group such as poly(N-methylvinylpyridinium) (PMVP), including poly(N-methyl-2-vinylpyridinium) (PM2VP), and copolymers thereof; poly(allylaminehydrochloride) (PAH), polyvinylamine, polyethyleneimine (PEI); a polysulfonium, or a polyphosphonium.

Aspect 13. The composite of any one of Aspects 1-4, wherein the negatively charged polyelectrolyte group comprises a sulfonate group, a carboxylate group, a phosphate group, or a phosphonate group.

Aspect 14. The composite of any one of Aspects 1-4, wherein the negatively charged polyelectrolyte polymer comprises poly(styrenesulfonic acid) (PSS), poly(2-acrylamido-2-methyl-1-propane sulfonic acid) (PAMPS), sulfonated poly (ether ether ketone) (SPEEK), poly(ethylenesulfonic acid), poly(methacryloxyethylsulfonic acid, or a copolymer or salt thereof; poly(acrylic acid) (PAA), poly(methacrylic acid), or a copolymer or salt thereof; sulfonated lignin, a polyphosphate, or a polyphosphonate.

Aspect 15. The composite of any one of Aspects 1-14, wherein the positively charged polyelectrolyte polymer and the negatively charged polyelectrolyte polymer has an average molecular weight of from about 1,000 grams/mole to about 5,000,000 grams/mole.

Aspect 16. The composite of Aspect 1, wherein the composite comprises a polysiloxane comprising a quaternary ammonium group at each end of the polysiloxane and a negatively charged polyelectrolyte polymer comprising sulfonate groups.

Aspect 17. The composite of Aspect 16, wherein the quaternary ammonium group is an ammonium group.

Aspect 18. The composite of Aspect 16 or 17, wherein the polysiloxane is polydimethylsiloxane (PDMS) and the negatively charged polyelectrolyte polymer is polystyrene sulfonate (PSS).

Aspect 19. The composite of any one of Aspects 1-18, wherein the polysiloxane has an average molecular weight of from about 1,000 grams/mole to about 5,000,000 grams/mole.

Aspect 20. The composite of any one of Aspects 1-19, wherein the molar ratio of the negatively charged groups of the negatively charged polyelectrolyte polymer to the positively charged groups of the positively charged polysiloxane is from 10:1 to 1:2.

Aspect 21. The composite of any one of Aspects 1-19, wherein the molar ratio of the positively charged groups of the positively charged polyelectrolyte polymer to the negatively charged groups of the negatively charged polysiloxane is from 10:1 to 1:2.

Aspect 22. The composite of any one of Aspects 1-21, wherein the positively charged polyelectrolyte polymer or the negatively charged polyelectrolyte polymer is crosslinked.

Aspect 23. The composite of any one of Aspects 1-22, wherein the polysiloxane is encapsulated by the positively charged polyelectrolyte polymer or the negatively charged polyelectrolyte polymer.

Aspect 24. The composite of any one of Aspects 1-23, wherein the composite comprises nanoparticles having a diameter less than 200 nm.

Aspect 25. The composite of any one of Aspects 1-24, wherein the composite further comprises an inorganic drying agent, a filler, a reinforcing agent, magnetic particles, a wet/dry indicator, or any combination thereof.

Aspect 26. The composite of any one of Aspects 1-24, wherein the composite further comprises a catalyst.

Aspect 27. The composite of any one of Aspects 1-24, wherein the composite further comprises a pharmaceutical agent.

Aspect 28. A composition comprising the composite of anyone of Aspects 1-27 and water.

Aspect 29. An article coated with the composite of any one of Aspects 1-27.

Aspect 30. A membrane or film comprising the composite of any one of Aspects 1-27

Aspect 31. A personal or home care product comprising the composite of any one of Aspects 1-27.

Aspect 32. A pharmaceutical composition comprising the composite of Aspect 27 and a pharmaceutically acceptable carrier.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

Materials and Methods.

Chloroform, sodium chloride (NaCl) and triflic acid (TfH) from Sigma Aldrich, deuterated chloroform (CDCl₃) were from Cambridge Isotope Laboratories, ethanol and HPLC water from VWR Chemicals, magnesium sulfate anhydrous from Fisher Scientific, polydiallyldimethylammonium chloride (PDAD) from Alfa Aesar, polydimethylsiloxane terminated at both ends with amino groups (10-15 cST nominal molecular weight) (PDMS-NH₂) from Gelest and polystyrene sulfonate (PSS, 16000 and 45000 g/mol, 16 k and 45 k, respectively) was from Scientific Polymer Products.

Protonation of PDMS-NH₂. 10 g (0.012 mol) PDMS-NH₂ was reacted with 2 mL (0.024 mol) triflic acid in 120 mL EtOH and left to stir at room temperature under nitrogen. Ethanol was then removed using a rotary evaporator under reduced pressure at room temperature, the crude product was dissolved in 120 mL chloroform and washed twice with water (1:1 CHCl₃:water). The organic layer was dried using anhydrous magnesium sulfate. The purified product was recovered from the chloroform layer by removing the solvent under reduced pressure at room temperature. PDMS-NH₃⁺ Tf (70% yield) was characterized using COSY and H-NMR in CDCl₃. The number average molecular weight Mₙ was determined to be 1375 g/mol. ¹H NMR (600 MHz, Chloroform-d) δ 6.82 (s, 6H), 3.03-2.92 (m, 4H), 1.76-1.63 (m, 4H), 0.59-0.53 (m, 4H), 0.18-0.01 (m, 117H).

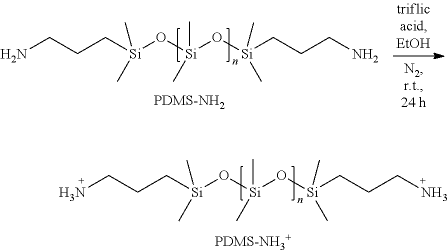

Nanoparticle Preparation. Flash nanoprecipitation was performed using a hand-operated confined impinging jet (CIJ). 50 mg of PDMS-NH₃⁺ was dissolved in 2.5 mL of THF and transferred to syringe A, while syringe B had the same volume of water (non-solvent). Both syringes were pressed simultaneously to rapidly mix the polymer and the non-solvent. The effluent from the CIJ mixer was then instantly diluted in excess (45 mL) water to obtain a THF:water ratio of 5:95. The total precipitation process occurs over a period of 2 s. To form the PSS shell, 30 mg of PSS was dissolved in the 45 mL water and the PDMS-NH₃⁺ nanoparticles were prepared using the same concentration and set-up.

Dynamic Light Scattering (DLS). The size and stability of the nanoparticles was determined using a goniometer system (ALV CGS-3-AO-111, Langen, Germany) equipped with a He—Ne Laser (λ=632.8 nm, 22 mW) and vertically polarized light. Measurements were taken once the sample was prepared at t=0 and after 24 h hours, in 10 mm capped cylindrical borosilicate glass tubes at an angle of 90° at room temperature through a reservoir filled with a refractive index matching liquid (toluene). The aqueous nanoparticle samples had a PDMS-NH₃⁺ concentration of 1 mg mL⁻¹ and were filtered through a 0.1 μm filter. 16 k and 45 k PSS were used to determine the effect of molecular weight by changing the concentration from 0 mg mL⁻¹ to 1.2 mg mL⁻¹. Their stability against 0.15 M NaCl was also monitored over 24 h. The intensity autocorrelation function g⁽²⁾ (q,T) where q=4πn_{D} sin(θ/2)/λ was obtained by pseudo-cross-correlation of the signals from two photomultipliers with suppressed noise by using ALV correlator software V.3.0. The hydrodynamic radius Rₕ was calculated along with its distribution.

PSS-PDMS-NH₃⁺ Film. PSS-PDMS-NH₃⁺ nanoparticle (i.e., PDMS with a PSS shell) solution was prepared. The dispersion was centrifuged using a Sorvall centrifuge at 14000 rpm for 4 hours. The PSS concentration left in the supernatant was determined using the absorbance measured using a UV-Vis spectrometer (Cary 100 Bio; Varian Instruments) at 225 nm. The precipitate was washed with 10 mL of water and dried under reduced pressure at room temperature for two days. The PSS and PDMS-NH₃⁺ content in the film was determined to have a 1:1 mole ratio. PSS-PDMS-NH₃⁺ films were prepared by pressing the particles using a lab press.

Imaging. PDMS-NH₃⁺ nanoparticles (0.1 mg/mL) were deposited on a PDAMA/PSS bilayer that was prepared using the layer-by-layer deposition technique and imaged using an MFP-3D AFM (Asylum Research Inc., Santa Barbara, CA) with an ARC2 controller and silicon TESPA-V2 probes (Bruker, radius=10 nm, spring constant=42 N m⁻¹). AC mode (intermittent contact) was employed, and the cantilever was adjusted to 5% below its resonance frequency.

Rheology. The linear viscoelastic response of the PSS-PDMS-NH₃⁺ film, the PDMS-NH₃⁺ polymer and the PDMS-NH₂ starting material was measured using a strain-controlled DHR-3 rheometer with 8 mm and 40 mm parallel plate, respectively. A temperature sweep experiment from 10 to 150° C. was performed on PSS-PDMS-NH₃⁺ film at 0.1% strain and ramp rate of 1° C. min-. Samples were annealed by an initial heating/cooling cycle before data collection. Frequency sweeps were performed from 0.01 to 100 Hz, with a strain of 0.1% at 25° C. The selected strain was made sure to be within the linear viscoelastic regime using amplitude sweep experiments.

X-ray Scattering. Simultaneous small angle (SAXS), mid angle (MAXS) and wide angle (WAXS) x-ray scattering data was collected at beamline 5-ID-D at the Advance Photon Source using a triple area detector system from Roper Scientific.

X-ray Data Analysis. SAXS/MAXS/WAXS data was averaged and the water background was subtracted using RAW. Data modeling and analysis was performed using the IRENA 2.7 package for Igor Pro 8.04. Particle properties were determined using a unified Guinier exponential and power law fit.

UV-VIS Absorbance. The absorbance of a 2-(furan-2-yl)-3-hydroxy-4H-chromen-4-one (FG38) (5×10⁻⁶ M) into a 1:1 PSS:PDMS-NH₃⁺ film was monitored at 358 nm over a 24-hour period using a UV-Vis spectrometer (Cary 100 Bio; Varian Instruments). The absorbance of FG38 in water was plotted vs time.

Fluorescence Measurements. The emission spectra of FG38 in water (5×10⁻⁶ M) and in the PSS-PDMS-NH₃⁺ film was recorded using an Edinburgh 298 FS5 steady-state spectrometer. Using a 150 W xenon lamp the samples were excited at a wavelength of 360 nm.

Results

### Example 1. PDMS Particles with and without Shell

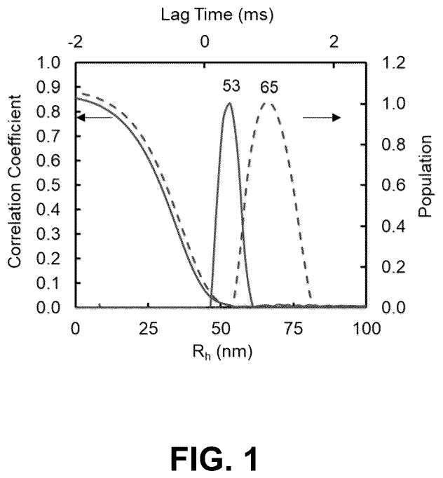

Solutions of PDMS-NH₃⁺ in THE were combined rapidly with water using the CIJ mixer. In some cases, the aqueous solution into which the particles were injected had no PSS and in other cases the water comprised PSS which formed a stabilizing shell around the PDMS-NH₃⁺ particles. The hydrodynamic radius Rh of PDMS particles with (PSS-PDMS-NH₃⁺) and without (PDMS-NH₃⁺) a stabilizing shell were compared. In both cases particles of Rh less than 70 nm were produced (FIG. 1).

### Example 2. Proof of Stabilizing Effect of PSS Shell

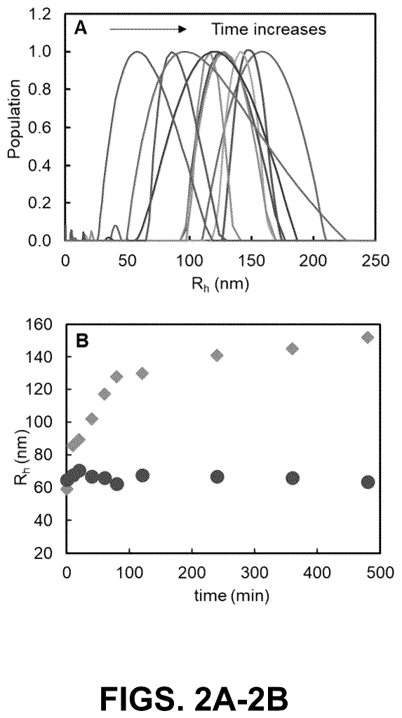

Partial colloidal stability of PDMS-NH₃⁺ particles in water was achieved through electrostatic repulsion of the positively charged nanoparticle surface. However, when 0.15 M NaCl was introduced to the nanoparticle reservoir an increase in hydrodynamic radius was recorded over the course of 8 hours (FIG. 2A). This indicates that the positive charge on the surface of the nanoparticle was insufficient to maintain stability by electrostatic repulsion, which led to aggregation. In contrast, the size of the PSS-PDMS-NH₃⁺ particle remained constant in salt water, indicating the stabilizing effect of the polyelectrolyte shell (FIG. 2B).

### Example 3. Image of Charged PDMS Particles

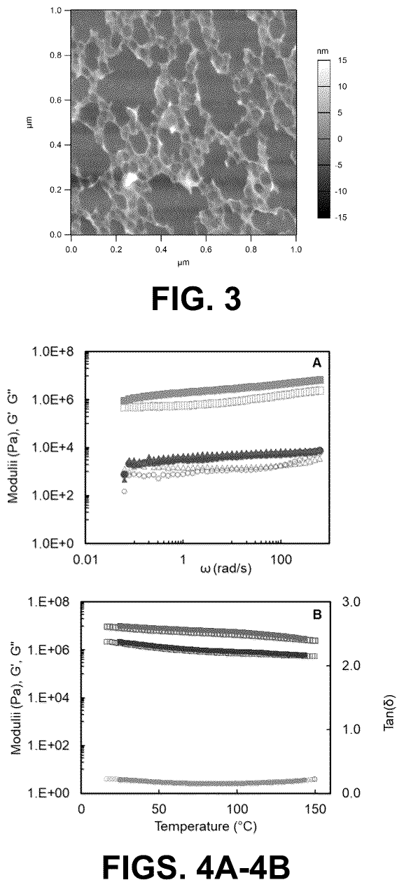

A dilute dispersion of PDMS-NH₃⁺ in water was allowed to dry on a silicon wafer. The particles were imaged with atomic force microscopy. FIG. 3 shows clusters of PDMS-NH₃⁺ on the silicon wafer.

### Example 4. Solid PSS-PDMS-NH₃+ Composite

The drastic difference in the mechanical properties of the nanoparticle shell and core lead to the formation of a polymer composite with interesting features. A PSS-PDMS-NH₃⁺ solid article was prepared by centrifuging down a PSS-PDMS-NH₃⁺ nanoparticle solution prepared using the previously mentioned CIP technique. The PSS and PDMS-NH₃⁺ form a complex with a 2:1 PDMS-NH₃⁺:PSS charge ratio.

The modulii G′ and G″ as well as the complex viscosity increased more than 100-fold when 14 wt % PSS was introduced indicating a more viscous glassy material at room temperature (FIG. 4A-4B).

### Example 5. Using Small Angle X-Ray Scattering (SAXS) to Determine Structure of PSS-PDMS-NH₃⁺

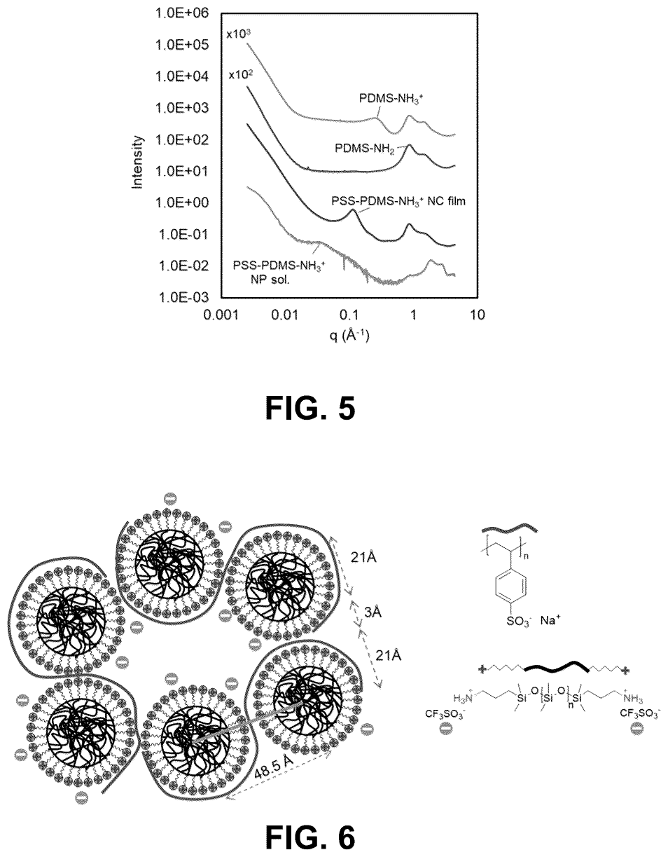

Pure PDMS-NH₃⁺ and PDMS-NH₂ (the unprotonated form of the PDMS) along with a 1 wt % solution of PSS-PDMS-NH₃⁺ and a solid film of PSS-PDMS-NH₃⁺ were subjected to SAXS in order to deduce the morphology of the PSS-PDMS-NH₃⁺ (FIG. 5). Analysis of the SAXS data was consistent with a structure as in FIG. 6.

### Example 6. Encapsulation of Gold Particles

Additives were included in the composite of the present invention. These additives include gold nanoparticles (Au-PDMS-NH₃⁺PSS); iron oxide nanoparticles (IONP-PDMS-NH₃⁺PSS); and silica nanoparticles SiO₂NP-PDMS-NH₃⁺PSS). The gold nanoparticles are an example of a catalytic particle additive. The iron oxide nanoparticle is an example of a magnetic particle additive. The silica nanoparticle is an example of a nonmetallic oxide nanoparticle additive. All examples of composite comprising nanoparticles were prepared by flash nanoprecipitation technique using the CIJ mixer disclosed herein.

For example, 4 mg of gold nanoparticles, AuNP, of diameter 10 nm and stabilized with a shell of oleylamine, which is hydrophobic, was dispersed in 0.5 mL THF. The AuNP solution was transferred to a solution of 25 mg PDMS-NH₃⁺ in 12.5 mL THF. The metal nanoparticle/polymer solution in THF was transferred to a syringe while another syringe had the same volume of non-solvent (water). Both syringes were actuated simultaneously, and the effluent was immediately precipitated into a reservoir of water (225 mL) containing 15 mg PSS to deposit a stabilizing shell of PSS on the nanodroplet of PDMS-NH₃⁺.

The same process was repeated to form IONP-PDMS-NH₃⁺ NPs with an IONP concentration of 0.032 mg mL-1. For the SiO₂-PDMS-NH₃⁺, the SiO₂ NPs were dispersed in isopropyl alcohol then redispersed in THF to yield a final SiO₂ NP concentration of 0.016 mg ml⁻¹.

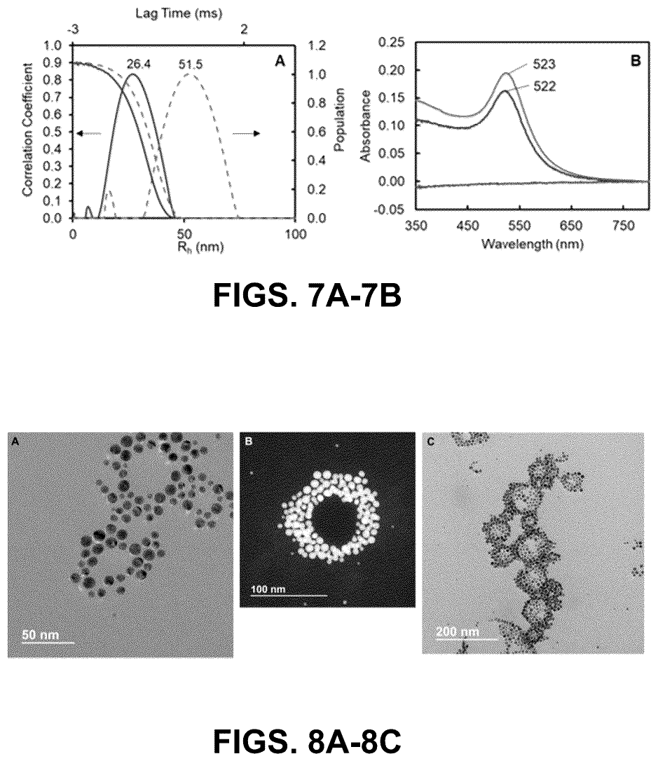

The composites formed well dispersed particles of approximately 100 nm diameter further comprising the nanoparticle additive, which had a smaller diameter. For example, the FIGS. 7A-7B show the size of composites, further comprising AuNP of diameter 10 nm, before and after the addition of a stabilizing shell of PSS. The AuNP did not aggregate within the composite since the surface plasmon resonance peak (SPR), which is sensitive to aggregation, did not shift significantly in wavelength.

Electron microscopy, (transmission electron microscopy, TEM, scanning transmission electron microscopy, STEM) showed the nanoparticles were included within the PDMS droplets comprising the composite (FIGS. 8A-8C).

In view of the above, it will be seen that the several objects of the invention are achieved and other advantageous results attained.

As various changes could be made in the above compositions and processes without departing from the scope of the invention, it is intended that all matter contained in the above description and shown in the accompanying drawings shall be interpreted as illustrative and not in a limiting sense.

1. A composite comprising (a) a polysiloxane comprising one or more positively charged groups and a negatively charged polyelectrolyte polymer or (b) a polysiloxane comprising one or more negatively charged groups and a positively charged polyelectrolyte polymer.

2. The composite of claim 1, wherein the polysiloxane comprises a dialkylpolysiloxane.

3. The composite of claim 1, wherein the polysiloxane comprises polydimethylsiloxane (PDMS).

4. The composite of claim 1, wherein the polysiloxane comprises a positively charged group or a negatively charged group at one or both ends of the polysiloxane.

5. The composite of claim 1, wherein the positively charged group comprises a quaternary ammonium group.

6. The composite of claim 1, wherein the positively charged group is NH₃⁺.

7. The composite of claim 1, wherein the positively charged polyelectrolyte polymer comprises a protonated or alkylated poly(pyridine), a protonated or alkylated poly(imidazole), a protonated or alkylated a poly(piperidine), or a protonated or alkylated poly(amine).

8. The composite of claim 1, wherein the positively charged polyelectrolyte polymer comprises poly(diallyldimethylammonium chloride) (PDADMA), poly(vinylbenzyltrimethylammonium) (PVBTA), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), including poly(N-methyl-2-vinylpyridinium) (PM2VP), and copolymers thereof; poly(allylaminehydrochloride) (PAH), polyvinylamine, polyethyleneimine (PEI); a polysulfonium, or a polyphosphonium.

9. The composite of claim 1, wherein the negatively charged polyelectrolyte group comprises a sulfonate group, a carboxylate group, a phosphate group, or a phosphonate group.

10. The composite of claim 1, wherein the negatively charged polyelectrolyte polymer comprises poly(styrenesulfonic acid) (PSS), poly(2-acrylamido-2-methyl-1-propane sulfonic acid) (PAMPS), sulfonated poly (ether ether ketone) (SPEEK), poly(ethylenesulfonic acid), poly(methacryloxyethylsulfonic acid, or a copolymer or salt thereof; poly(acrylic acid) (PAA), poly(methacrylic acid), or a copolymer or salt thereof; sulfonated lignin, a polyphosphate, or a polyphosphonate.

11. The composite of claim 1, wherein the composite comprises a polysiloxane comprising an ammonium group at each end of the polysiloxane and a negatively charged polyelectrolyte polymer comprising sulfonate groups.

12. The composite of claim 1, wherein the polysiloxane is polydimethylsiloxane (PDMS) and the negatively charged polyelectrolyte polymer is polystyrene sulfonate (PSS).

13. The composite of claim 1, wherein the molar ratio of the negatively charged groups of the negatively charged polyelectrolyte polymer to the positively charged groups of the positively charged polysiloxane is from 10:1 to 1:2.

14. The composite of claim 1, wherein the molar ratio of the positively charged groups of the positively charged polyelectrolyte polymer to the negatively charged groups of the negatively charged polysiloxane is from 10:1 to 1:2.

15. The composite of claim 1, wherein the polysiloxane is encapsulated by the positively charged polyelectrolyte polymer or the negatively charged polyelectrolyte polymer.

16. The composite of claim 1, wherein the composite comprises nanoparticles having a diameter less than 200 nm.

17. The composite of claim 1, wherein the composite further comprises an inorganic drying agent, a filler, a reinforcing agent, magnetic particles, a wet/dry indicator, a catalyst, a pharmaceutical agent, or any combination thereof.

18. An article coated with the composite of claim 1.

19. A personal or home care product comprising the composite of claim 1.

20. A pharmaceutical composition comprising the composite of claim 1 with a pharmaceutical agent and a pharmaceutically acceptable carrier.
